(19) United States
(12) Patent Application Publication
(10) Pub. No.: US 2003/0076735 A1
(43) Pub. Date: Apr. 24, 2003

(54) Signage on rotating concrete mixer drums

(76) Inventor: John H. Niland, Dallas, TX (US)

Correspondence Address: KENNETH R. GLASER, GARDERE WYNNE SEWELL LLP, Suite 3000, 1601 Elm Street, Dallas, TX, 75201-4761, US

(21) Appl. No.: 09/982,582

(22) Filed: Oct. 18, 2001

(51) Int. Cl. B28C 5/18; B60R 13/00

(52) U.S. Cl. 366/54; 296/21; D20/35

(57) ABSTRACT

Over-the-road concrete mixer motor trucks with rotatable concrete mixer drums have indicia placed on the drums comprising advertisements of a product or service, and which may be readable from opposite sides of the motor truck as it traverses a roadway. In alternate embodiments, indicia on the rotatable mixer drum is placed in a helical or spiral fashion or simulates the appearance of an article other than the drum itself.

### BACKGROUND

Many unique advertising media have been developed including signage on over-the-road vehicles. Certain vehicles lend themselves to more attractive and “eye catching” signage. For example, portable rotating concrete mixer drums mounted on over-the-road motor trucks offer a heretofore unappreciated form of advertising media. It is to these ends that the present invention has been developed.

### BRIEF SUMMARY OF THE INVENTION

The present invention provides improved advertising media comprising an over-the-road motor vehicle including a rotating concrete mixer drum mounted thereon with advertising, other signage or unique indicia disposed on the mixer drum.

In accordance with one aspect of the present invention, a unique advertising medium has been provided comprising an over-the-road motor vehicle characterized as a so-called mixer truck and including a generally cylindrical or oval shaped rotating concrete mixer drum. In normal transit, the mixer drum is rotating as the vehicle traverses a roadway and signage is displayed on the mixer drum in a way which attracts attention, thereby providing an improved advertising medium.

In accordance with another aspect of the present invention, an over-the-road concrete mixer truck is provided with a rotating, generally cylindrical drum which includes signage or other indicia thereon which is unique and takes advantage of the shape of the drum. For example, indicia which tends to make the rotating concrete mixer drum look like another object, such as a football or another familiar article, may be provided.

In accordance with a still further aspect of the present invention, an over-the-road concrete mixer motor truck may include signage formed on the rotatable mixer drum which is arranged on the drum to take advantage of the shape of the drum and the fact that it normally rotates while the vehicle is in transit.

Those skilled in the art will further appreciate the above-mentioned features and superior aspects of the present invention upon reading the detailed description which follows in conjunction with the drawing.

### BRIEF DESCRIPTION OF THE SEVERAL VIEWS OF THE DRAWINGS

FIG. 1 is a side elevation of an over-the-road concrete mixer motor truck including signage provided on its rotatable concrete mixer drum;

FIG. 2 is a side elevation of an over-the-road concrete mixer truck showing a first alternate embodiment of signage on the rotatable mixer drum, which signage is configured to take advantage of the shape and rotation of the drum;

FIG. 3 is a side elevation of a concrete mixer truck similar to the embodiments of FIGS. 1 and 2 and showing signage and related indicia on the rotatable mixer drum which also takes advantage of the shape and rotation of the drum; and

FIG. 4 is a side elevation of a concrete mixer truck similar to the vehicles shown in FIGS. 1-3 and showing yet another embodiment of indicia on a rotatable mixer drum which takes advantage of the shape of the drum.

### DETAILED DESCRIPTION OF THE PREFERRED EMBODIMENTS

In the description which follows, like parts are marked throughout the specification and drawing with the same reference numerals, respectively. The drawing figures are not intended to be to scale and exemplary embodiments of advertising or similar indicia placed on the rotatable mixer drum are presented.

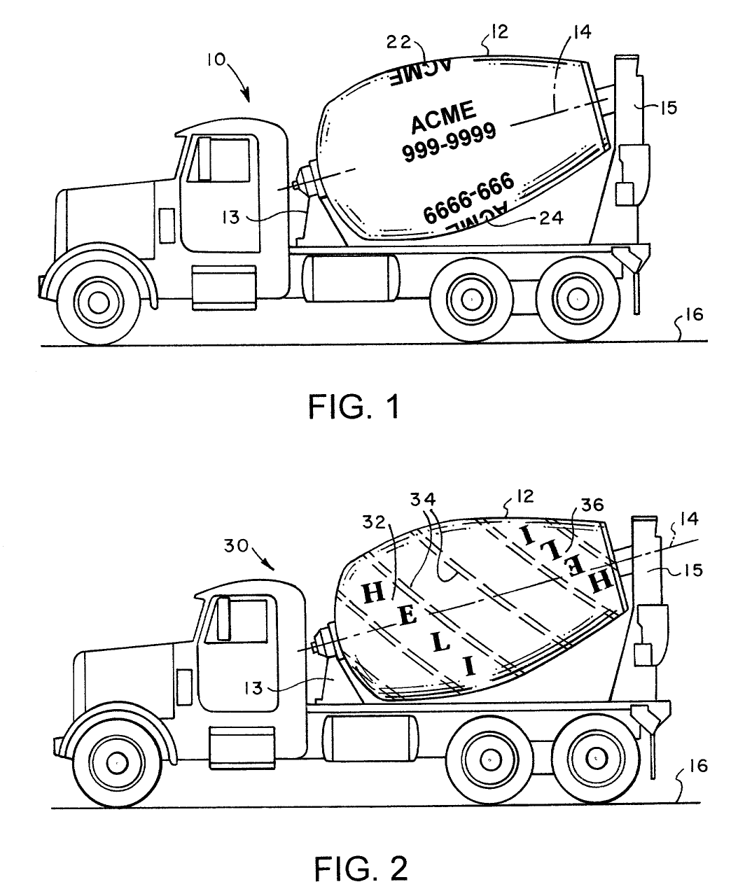

Referring to FIG. 1, there is illustrated an over-the-road motor truck, generally designated by the numeral 10. The motor truck 10 includes a rotatable concrete mixer drum 12 supported thereon for rotation about a somewhat rearwardly and upwardly inclined central longitudinal axis 14. The axis 14 is inclined with respect to a horizontal roadway 16 on which the vehicle 10 would normally traverse. The mixer drum 12 is supported between spaced-apart suitable supports 13 and 15 in a conventional manner. Other equipment, including a concrete mix discharge chute, normally associated with over-the-road concrete mixer motor trucks is not illustrated, as it forms no part of the present invention. Rotatable concrete mixer drums, such as the drum 12 are generally cylindrical in shape but may be tapered somewhat toward the axis 14 from the support 13 to the support 15. Various mixer drum shapes are provided. Some are reminiscent of natural or manmade shapes, such as fruit, including apples, pears or plums or certain sports articles, such as a basketball or football.

A rotatable concrete mixer drum provides a unique advertising media when mounted on an over-the-road motor vehicle. The public exposure for advertising placed on such a drum is substantial as a consequence of the high utilization of the capital intensive equipment associated with the concrete supply industry.

The present invention includes the placement of messages, or advertisements on portable over the road mixer drums, such as the drum 12 and indicated in FIG. 1 at numeral 20. To facilitate reading the message or advertisement 20 on the drum 12 from opposite sides of the vehicle, the message is repeated one or more times, such as indicated at 22 and 24, but readable in the opposite direction or side of the vehicle from that of the message or advertisement 20. The message or advertisement 20 may be repeated on the drum 12 at approximately 180 degrees with respect to the axis 14, and not shown in FIG. 1.

Referring to FIG. 2, there is illustrated a first alternate embodiment in accordance with the invention of an over-the-road concrete mixer truck generally designated by the numeral 30. The concrete mixer truck 30 includes the same components as the over-the-road truck 10, although the mixer drum 12 has indicia or advertising thereon indicated by numerals 32, 34 and 36 which differs from the indicia on the drum shown in FIG. 1. The indicia 32 and 36 may comprise readable words which are oriented on the surface of the drum 12 in FIG. 2 such that the word becomes visible in its entirety as the drum rotates when viewed from opposite sides of the vehicle 30. Still further, indicia such as the helical lines 34 are eye-catching when painted in a color that is in contrast to that of drum 12, particularly when the drum is rotating. In other words, a barber pole or candy cane visual effect may be taken advantage of by providing suitable indicia in the way of a message or advertisement on the drum 12 of the vehicle 30.

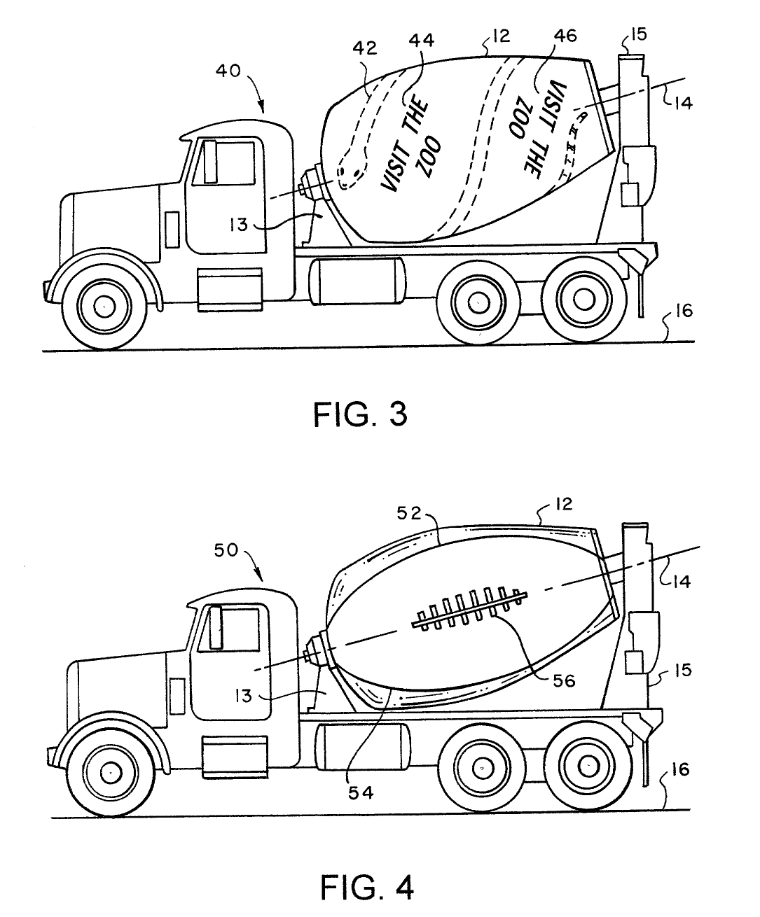

Still further with regard to FIG. 3, an embodiment of an over-the-road concrete mixer truck 40 is illustrated wherein all of the components of the vehicles or trucks 10 and 30 are present and the vehicle 40 is otherwise identical to the vehicles 10 and 30, except for the indicia on the mixer drum 12. As shown in FIG. 3, the image of a coiled snake 42 and the message “VISIT THE ZOO”, indicated by numerals 44 and 46, is displayed on the drum and readable from opposite sides of the vehicle as it traverses a roadway.

Still further, viewing FIG. 4, another embodiment of the invention is illustrated and generally designated by the numeral 50. The over-the-road concrete mixer truck 50 is identical to the trucks 10, 30 and 40 in substantially all respects except for the indicia on the mixer drum 12. In the embodiment of FIG. 4, the mixer drum 12 has been provided with suitable indicia to look like a football, including longitudinal seams 52 and 54 and lacings 56. The drum 12 of vehicle or motor truck 50 may be painted the natural leather color of a football and the seams 52 and 54 may be painted the colors of a particular football team, for example. Other indicia, such as a team name, may also be provided, for example. Still other forms of advertising in the way of messages or the name of a product or a service source may be placed on the surface of the drum 12 of the vehicles or trucks 10, 30, 409 and 50.

Those skilled in the art will appreciate that various other configurations of advertising or eye-catching indicia may be placed on portable rotatable concrete mixer drums in accordance with the invention. The indicia shown in the embodiments of FIGS. 1-4 are merely examples which take advantage of the shape of a portable concrete mixer drum and the fact that it rotates during presentation of the message such as when the vehicle is in transit or is at the site of delivery of its cargo. Those skilled in the art will further appreciate that various substitutions and modifications may be made to the invention without departing from the scope and spirit of the appended claims.

What is claimed is:

1. An over-the-road concrete mixer motor truck having a rotatable concrete mixer drum mounted thereon, said concrete mixer drum including indicia thereon providing one of an advertising message and an eye-catching presentation which is facilitated by the shape of the drum and its rotation.

2. The concrete mixer truck set forth in claim 1 wherein:
said indicia is displayed in a helical coil on an outer surface of said drum.

3. The concrete mixer truck set forth in claim 1 wherein:
said indicia is configured to indicate an object selected from a group consisting of a ball used in an athletic endeavor and an object having a shape similar to the drum.

4. The concrete mixer truck set forth in claim 3 wherein:
said indicia is configured to simulate the appearance of a football.

5. A method for displaying one of a message and advertising a product or service comprising the steps of:
providing an over-the-road concrete mixer truck having a generally cylindrical concrete mixer drum mounted thereon for rotation about a longitudinal axis of said drum; and
providing indicia on said drum which utilizes at least one of the shape and rotation of said drum to provide a visual display.

6. The method set forth in claim 5 including the step of:
applying indicia to said drum which is readable from opposite sides of said truck when said truck is traversing a roadway and said drum is rotating.

7. The method set forth in claim 5 including the step of:
applying indicia to said drum which has a pattern which is one of helical and spiral.

8. The method set forth in claim 5 including the step of:
applying indicia to said drum which simulates the appearance of an article other than said drum.
